(19) United States
(12) Patent Application Publication
(10) Pub. No.: US 2017/0163160 A1
(43) Pub. Date: Jun. 8, 2017

(54) MODULAR BATTERY ARRAYS AND ASSOCIATED METHODS

(71) Applicant: The Trustees of Dartmouth College, Hanover, NH (US)

(72) Inventors: Eric DIN, Seattle, WA (US); Christopher SCHAEF, Beaverton, OR (US); Keith MOFFAT, Berkeley, CA (US); Jason T. STAUTH, Hanover, NH (US)

(21) Appl. No.: 15/368,442

(22) Filed: Dec. 2, 2016

Related U.S. Application Data
(60) Provisional application No. 62/263,244, filed on Dec. 4, 2015.

(51) Int. Cl. H02M 3/335; H02M 1/08

(52) U.S. Cl. CPC H02M 3/33507; H02M 1/08; H02M 2001/0009

(57) ABSTRACT

A modular battery array includes a plurality of battery modules electrically coupled in series to a high-voltage electric power bus, a low-voltage electric power bus, and a respective switching power converter electrically interfacing each of the plurality of battery modules with the low-voltage electric power bus. Each of the plurality of battery modules includes a plurality of battery cells electrically coupled in series and at least one switching power converter for balancing energy stored in the plurality of battery cells of the battery module.

### RELATED APPLICATIONS

This application claims benefit of priority to U.S. Provisional Patent Application Ser. No. 62/263,244 filed Dec. 4, 2015, which is incorporated herein by reference.

### GOVERNMENT RIGHTS

This invention was made with government support under Grants ECCS-1407725 and 1542984 awarded by the National Science Foundation. The government has certain rights in the invention.

### BACKGROUND

Batteries are used to provide electrical power in a wide variety of applications. For example, batteries are commonly used to power mobile information technology devices, such as cellular telephones and notebook computers. As another example, batteries are increasingly being used as a primary power source in vehicles.

A single battery cell is typically capable of providing electric power at only a small voltage magnitude. Therefore, a plurality of battery cells are often electrically coupled in series to form a battery, to achieve a voltage magnitude that is sufficiently large for the battery's intended application. Electrical output of the battery is limited by the weakest battery cell in a series string of the battery, however. Batteries may also be strung together in series, or series-parallel, to achieve even higher voltages in a battery array. Additionally, battery cells of each battery, or batteries of a battery array, will often charge and discharge in a non-uniform manner, due to differences among individual battery cells of the battery, or between batteries of a battery array. Such differences occur, for example, due to manufacturing variations in the battery cells or unequal aging of the battery cells.

Accordingly, it is desirable to balance energy stored in battery cells of a battery, or in other words, to cause each battery cell in the battery to store about the same amount of energy, to maximize battery capacity and to prolong battery life. Battery cell balancing is conventionally achieved, for example, using dissipative cell balancing techniques, where energy stored in stronger battery cells is resistively dissipated so that each cell in the battery stores roughly the same amount of energy, such as to promote safety and battery longevity. Dissipative cell balancing techniques have significant drawbacks, however. For example, dissipative cell balancing techniques cause power loss which may waste power and result in undesired heating. As another example, dissipative cell balancing techniques are only effective at the end of a battery's charge cycle, thereby limiting their use.

### SUMMARY

In an embodiment, a modular battery array includes a plurality of battery modules electrically coupled in series to a high-voltage electric power bus, a low-voltage electric power bus, and a respective switching power converter electrically interfacing each of the plurality of battery modules with the low-voltage electric power bus. Each of the plurality of battery modules includes a plurality of battery cells electrically coupled in series and at least one switching power converter for balancing energy stored in the plurality of battery cells of the battery module.

In an embodiment, a method for balancing energy stored in a modular battery array including a plurality of battery modules electrically coupled in series includes the following steps: (a) in each of the plurality of battery modules, transferring energy between battery cells within the battery module using at least one first switching converter within the battery module, to balance energy stored in the battery cells within the battery module, and (b) transferring energy between battery cells of at least two of the plurality battery modules using respective second switching power converters electrically coupled to each of the plurality of battery modules, to balance energy stored in the plurality of battery modules.

### BRIEF DESCRIPTION OF THE DRAWINGS

FIG. 1 illustrates a modular battery array, according to an embodiment.

FIG. 2 illustrates details of one instance of a battery module of the modular battery array of FIG. 1.

FIG. 3 illustrates a battery module including a plurality of switching power converters collectively forming a multi-stage ladder converter, according to an embodiment.

FIG. 4 illustrates details of one instance of the switching power converters of FIG. 3.

FIG. 5 illustrates a battery module in an embodiment of the FIG. 1 modular battery array supporting electrochemical impedance spectroscopy.

FIG. 6 illustrates a method for balancing energy stored in a modular battery array, according to an embodiment.

FIG. 7 illustrates a full-bridge isolated DC-to-DC converter, according to an embodiment.

FIG. 8 illustrates a current sensing circuit, according to an embodiment.

FIG. 9 illustrates a voltage sensing circuit, according to an embodiment.

### DETAILED DESCRIPTION OF THE EMBODIMENTS

Applicant has developed modular battery arrays and associated methods which may achieve significant advantages over conventional batteries and battery management schemes. The modular battery arrays include a plurality of series-connected battery modules, where each battery module includes a plurality of series-connected battery cells. The modular battery arrays further include at least two switching power converters having different topologies, to balance cost and performance. Additionally, the modular battery arrays potentially achieve battery cell balancing over a wide range of operating conditions, thereby promoting large capacity and long life of the battery array. Furthermore, the modular battery arrays may achieve battery cell balancing with significantly smaller power losses than those typically incurred when using conventional dissipative cell balancing techniques. Moreover, the division of battery cells of the arrays into a plurality of modules may make assembly and maintenance of the modular battery arrays easier and safer relative to conventional batteries.

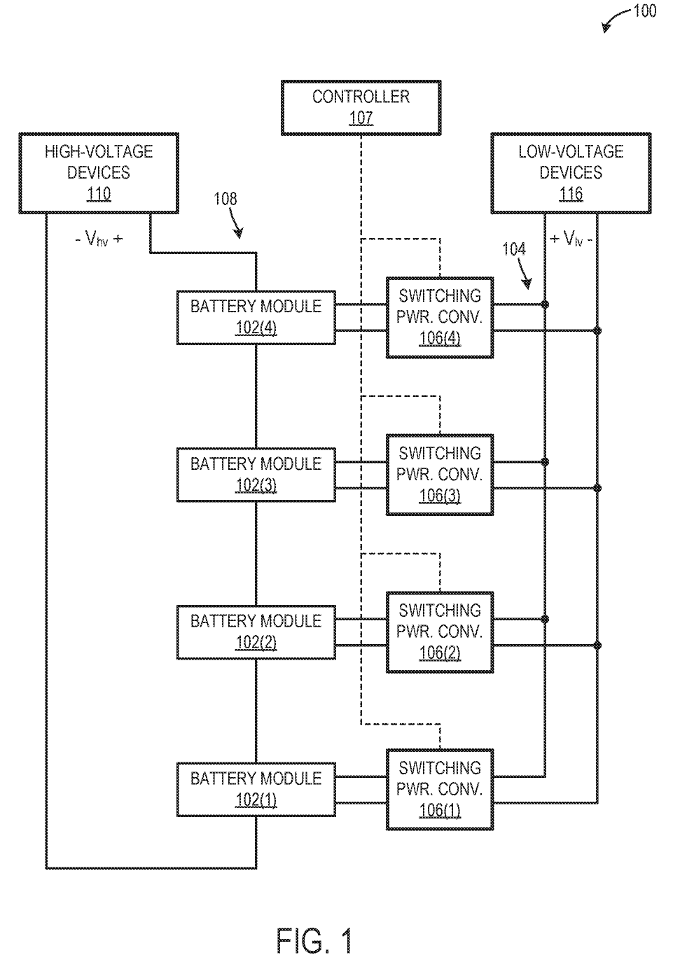

FIG. 1 illustrates a modular battery array 100 including a plurality of battery modules 102, a low-voltage electric power bus 104, a respective switching power converter 106 for each battery module 102, and a controller 107. In this document, specific instances of an item are referred to by use of a numeral in parentheses (e.g., battery module 102(1)) while numerals without parentheses refer to any such item (e.g., battery modules 102). The term “switching power converter” in this document refers to a device which transfers power by causing at least one switching device to repeatedly switch between its conductive and non-conductive states to charge and/or discharge an energy storage device, such as an inductor or capacitor. Additionally, the term “switching device” in this document means a device capable of being repeatedly switched between its conductive and non-conductive states, such as a bipolar junction transistor (BJT), a field effect transistor (FET), or an insulated gate bipolar junction transistor (IGBT).

The plurality of battery modules 102 are electrically coupled in series to a high-voltage electric power bus 108, which is electrically coupled to high-voltage devices 110. High-voltage devices 110 include one or more of a high-voltage load (not shown) powered from modular battery array 100 and a high-voltage electric power source (not shown) for charging modular battery array 100. The number of battery modules 102 and associated switching power converters 106 may be varied without departing from the scope hereof.

Each switching power converter 106 electrically interfaces its respective battery module 102 to low-voltage electric power bus 104 to control power transfer between the battery module 102 and low-voltage electric power bus 104. Although FIG. 1 illustrates switching power converters 106 being electrically coupled to low-voltage electric power bus 104 in parallel, switching power converters 106 could alternately be electrically coupled to low-voltage electric power bus 104 in series. Low-voltage electric power bus 104 is optionally electrically coupled to low-voltage devices 116. Low voltage devices 116 include, for example, one or more of a low-voltage load (not shown) powered from modular battery array 100 and a low-voltage electric power source (not shown) for charging modular battery array 100. As discussed further below, controller 107 controls switching power converters 106 to balance energy stored in battery modules 102. Although low-voltage devices 116 and high-voltage devices 110 are electrically coupled to modular battery array 100, low-voltage devices 116 and high-voltage devices 110 are optionally separate from modular battery array 100.

While not required, it is anticipated that a magnitude of a voltage Vₕᵥ across high-voltage electric power bus 108 is greater than a magnitude of a voltage Vₗᵥ across low-voltage electric power bus 104. In embodiments of modular battery array 100 for use in an electric vehicle, high-voltage devices 110 include, for example, one or more electric motors for propelling the electric vehicle, low-voltage devices 116 include, for example, a battery and one or more peripheral loads, such as headlights and electronic control units, and magnitude of voltage Vₗᵥ across low-voltage electric power bus 104 is nominally 12 volts, for example.

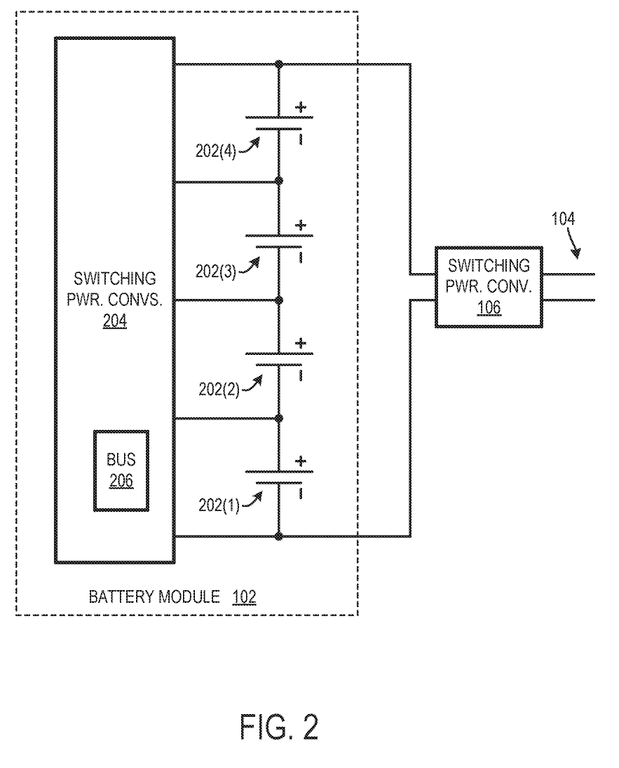

FIG. 2 illustrates details of one instance of battery module 102. All other instances of battery module 102 are formed in like manner. Each battery module 102 includes a plurality of battery cells 202 electrically coupled in series and one or more switching power converters 204. The term “battery cell” in this document refers to any unit of electrochemical energy storage that has a positive and negative electrical terminal. Thus, a battery cell can include multiple electrically-coupled electrochemical energy storage devices. The number of battery cells 202 in battery module 102 may be varied without departing from the scope hereof.

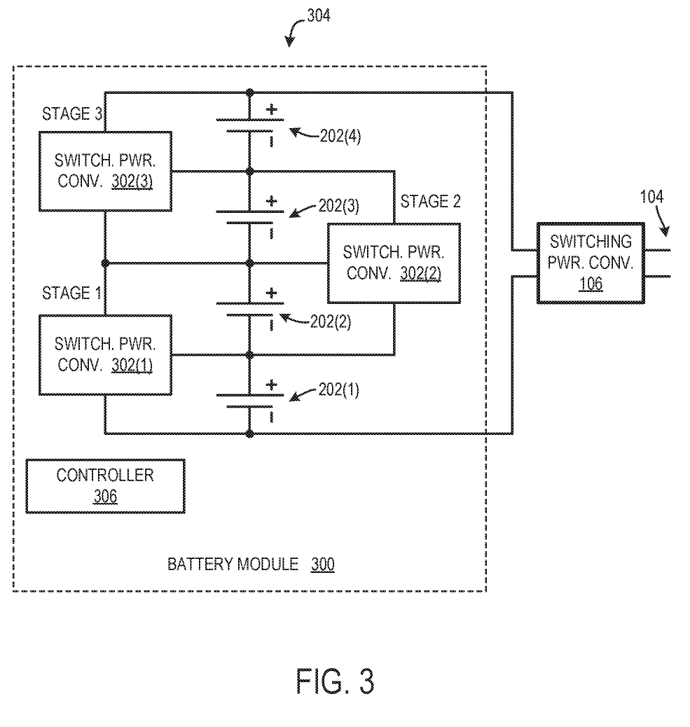

Switching power converters 204 are configured to balance energy stored in battery cells 202 of battery module 102, or in other words, to cause each battery cell 202 in battery module 102 to store about the same amount of energy, to maximize battery module 102's capacity and to prolong battery module 102's life. Switching power converters 204 can have any topology capable of transferring energy between battery cells 202 in battery module 102. Although switching power converters 204 are illustrated as a single element, in some embodiments, switching power converters 204 are formed of multiple elements, such as discussed below with respect to FIG. 3. In some embodiments, switching power converters 204 use a common electric power bus 206 to transfer energy between battery cells 202. In some other embodiments, energy is transferred between instances of switching power converter 204 without use of a common electric power bus, and common electric power bus 206 is therefore omitted, such as shown in FIG. 3.

FIG. 3 illustrates one embodiment of battery module 102 without common electric power bus 206. In particular, FIG. 3 illustrates a battery module 300, which is one embodiment of battery module 102 and includes a plurality of switching power converters 302 collectively forming a multi-stage ladder converter 304. Battery module 300 includes one less switching power converter 302 than the number of battery cells 202 in battery module 300. Each switching power converter 302 is electrically coupled across two respective instances of battery cells 202. As discussed below, a controller 306 in battery module 300 causes each switching power converter 302 to transfer energy between its two respective battery cells 202, so that switching power converters 302 are collectively capable of shuffling energy up and down battery cells 202 as necessary to balance energy stored in battery cells 202. Although controller 306 is illustrated as being a single element, controller 306 may be distributed among multiple elements. Controller 306 is implemented by hardware, a computing device executing instructions in the form of software or firmware, or a combination thereof. The computing device includes, for example, a processor communicatively coupled to a memory, and the processor executes instructions in the form of software or firmware stored in the memory, to implement one or more functions of controller 306.

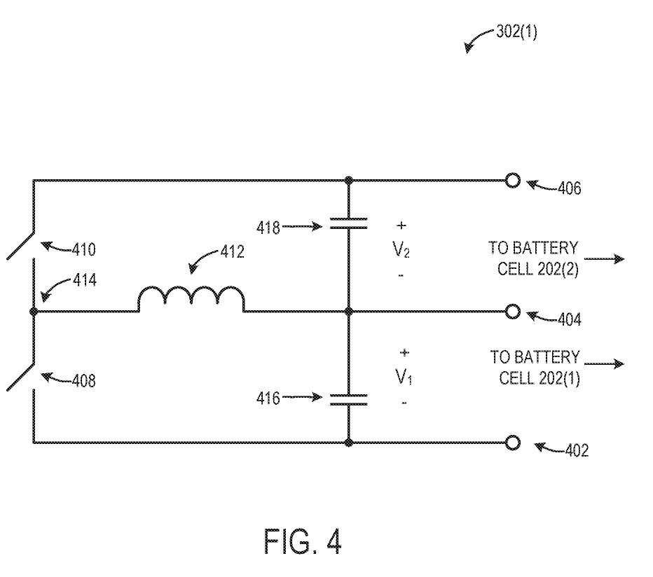

FIG. 4 illustrates details of switching power converter 302(1). Other instances of switching power converters 302 are implemented in a like manner. Switching power converter 302(1) includes a first terminal 402, a second terminal 404, a third terminal 406, a first switching device 408, a second switching device 410, an inductor 412, a first capacitor 416, and a second capacitor 418. First switching device 408 is electrically coupled between first terminal 402 and a switching node 414, and second switching device 410 is electrically coupled between switching node 414 and third terminal 406. Inductor 412 is electrically coupled between switching node 414 and second terminal 404. First capacitor 416 is electrically coupled between first terminal 402 and second terminal 404, and second capacitor 418 is electrically coupled between second terminal 404 and third terminal 406. First and second terminals 402 and 404 are electrically coupled across battery cell 202(1), and second and third terminals 404 and 406 are electrically coupled across immediately adjacent battery cell 202(2).

A ratio of voltage V₂ across battery cell 202(2) to voltage V₁ across battery cell 202(1) is equal to D₁/(1−D₁), where D₁ is a duty cycle of first switching device 408, which is the portion of each switching cycle of switching power converter 302(1) where first switching device 408 is operating in its conductive state. Consequentially, energy can be transferred between battery cells 202(1) and 202(2) by adjusting D₁, since changing the ratio of V₂ to V₁ will cause energy to be transferred between battery cells 202(1) and 202(2). The direction of energy transfer is determined by the polarity of change in D₁, and the amount of energy transferred is a positive function of the magnitude of change in D₁. However, the ratio V₂/V₁ may be difficult to instrument and use as a control parameter because the ratio is nonlinear and is computational intensive to determine. Therefore, in some embodiments, each switching power converter 302 is at least partially controlled by controller 306 according to Δv, which is the difference between voltages of its two respective battery cells 202, e.g. the difference between V₁ and V₂ in switching power converter 302(1). When one of first and second switching devices 408 and 410 changes from its conductive state to its non-conductive state, the other switching device 408 or 410 operates in its conductive state, to provide a path for current flowing through inductor 412.

Controller 306 controls Δv of each switching power converter 302 as needed to at least substantially equalize energy stored in battery cells 202 by transferring energy between adjacent battery cells in battery module 300. For example, assume that battery cell 202(1) is storing excessive energy, battery cell 202(2) is storing a desired amount of energy, and battery cell 202(3) is storing insufficient energy. Controller 306 causes transfer of energy from battery cell 202(1) to battery cell 202(3) by adjusting Δv to switching power converter 302(1) so that D₁ of switching power converter 302(1) changes and causes switching power converter 302(1) to transfer energy from battery cell 202(1) to battery cell 202(2), and then by adjusting Δv to switching power converter 302(2) so that D₁ of switching power converter 302(2) changes and causes switching power converter 302(2) to transfer energy from battery cell 202(2) to battery cell 202(3).

Returning to FIG. 1, controller 107 controls switching power converters 106 to transfer energy between battery modules 102 using low-voltage electric power bus 104, to balance energy stored in the battery modules. For example, assume battery module 102(1) is storing excess energy it its respective battery cells 202, and assume battery module 102(3) is storing insufficient energy in its respective battery cells 202. Controller 107 causes switching power converter 106(1) to transfer energy from battery module 102(1) to low-voltage electric power bus 104, and controller 107 causes switching power converter 106(3) to transfer energy from low-voltage electric power bus 104 to battery module 102(3), so that energy is transferred from battery module 102(1) to battery module 102(3) to balance energy stored in battery modules 102. Controller 107 controls switching power converters 106, for example, by controlling duty cycle of one or more switching devices of each switching power converter 106.

Accordingly, modular battery array 100 implements two levels of energy transfer, to balance energy stored in battery cells 202. Switching power converters 204 balance energy stored within battery cells 202 of a given battery module 102, and switching power converters 106 and low-voltage electric power bus 104 collectively balance energy stored in battery cells 202 of different battery modules 102. This dual-level charge transfer architecture helps minimize the number of switching power converters processing power, which is advantageous because power is lost whenever a switching power converter processes power. For example, assume that energy needs to be transferred from a battery cell 202 of battery module 102(1) to a battery cell 202 of battery module 102(4). Switching power converters 106(1) and 106(4) transfer this energy between battery module 102(1) and battery module 102(4) without requiring that the energy pass through switching power converters 204 of intervening battery modules 102(2) and 102(3). If modular battery array 100 did not include switching power converters 106, energy passing from battery module 102(1) to battery module 102(4) would need to pass through intervening battery modules 102(2) and 102(3), thereby potentially resulting in significant losses.

In some embodiments, switching power converters 106 have an isolated electrical topology, such as to achieve galvanic isolation between battery modules 102 and low-voltage electric power bus 104, i.e. where no current is shared between battery modules 102 and low-voltage electric power bus 104. Use of an isolated electrical topology may also facilitate electrically interfacing battery modules 102 with low-voltage electric power bus 104 because battery modules 102 may be at a much higher voltage than low-voltage electric power bus 104. Some possible electrical topologies of switching power converters 106 include, but are not limited to, a flyback-type converter, a forward-type converter, a half bridge-type converter, and a full bridge-type converter.

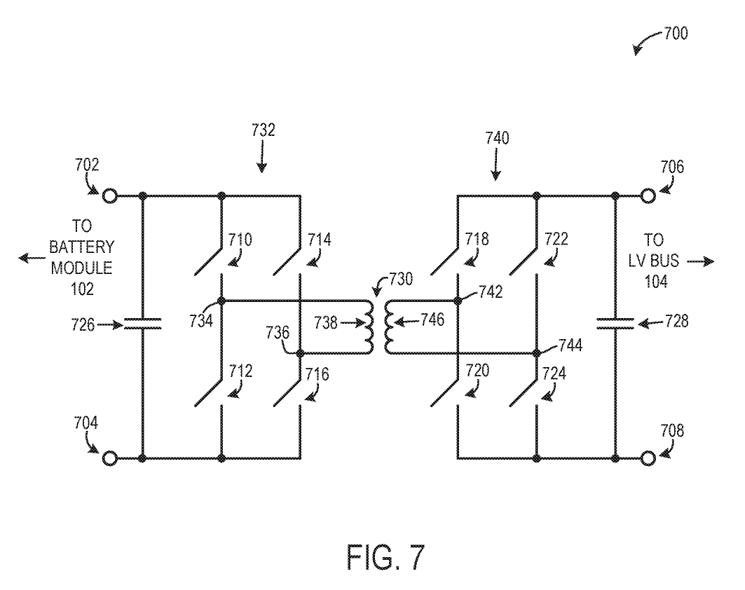

For example, in some embodiments of system 100, each switching power converter 600 is implemented as a full-bridge isolated DC-to-DC converter 700 illustrated in FIG. 7. DC-to-DC converter 700 includes terminals 702, 704, 706, 708, switching devices 710, 712, 714, 716, 718, 720, 722, 724, a first capacitor 726, a second capacitor 728, and a transformer 730. Terminals 702 and 704 electrically couple to a respective battery module 102, and terminals 706 and 708 electrically coupled to low-voltage electric power bus 104. First capacitor 726 is electrically coupled between terminals 702 and 704, and second capacitor 728 is electrically coupled between terminals 706 and 708.

Switching devices 710, 712, 714, and 716 form a full-bridge first switching stage 732. In particular, switching device 710 is electrically coupled between terminal 702 and a first switching node 734, and switching device 712 is electrically coupled between first switching node 734 and terminal 704. Switching device 714 is electrically coupled between terminal 702 and a second switching node 736, and switching device 716 is electrically coupled between second switching node 736 and terminal 704. A first winding 738 of transformer 730 is electrically coupled between first switching node 734 and second switching node 736.

Switching devices 718, 720, 722, and 724, in turn, form a full-bridge second switching stage 740. In particular, switching device 718 is electrically coupled between terminal 706 and a third switching node 742, and switching device 720 is electrically coupled between third switching node 742 and terminal 708. Switching device 722 is electrically coupled between terminal 706 and a fourth switching node 744, and switching device 724 is electrically coupled between fourth switching node 744 and terminal 708. A second winding 746 of transformer 730 is electrically coupled between third switching node 742 and fourth switching node 744.

Controller 107 controls each instance of switching power converter 700 to transfer energy between battery modules 102 using low-voltage electric power bus 104, to balance energy stored in the battery modules. In particular, when a given switching power converter 700 instance needs to transfer energy from its respective battery module 102 to low-voltage electric power bus 104, controller 107 causes first switching stage 732 of the switching power converter to act as an inverter, and controller 107 causes second switching stage 740 of the switching power converter to act as a rectifier, such that energy flows from the battery module to low-voltage electric power bus 104. First switching stage 732 acts as an inverter by converting a DC voltage across terminals 702 and 704 to an AC voltage across first winding 738 of transformer 730, and transformer 730 transforms the AC voltage across first winding 738 to an AC voltage across second winding 746 of transformer 730. Second switching stage 740 acts as a rectifier by converting the AC voltage across second winding 746 to a DC voltage across terminals 706 and 708.

On the other hand, when a given switching power converter 700 instance needs to transfer energy from low-voltage electric power bus 104 to its respective battery module 102, controller 107 causes second switching stage 740 to act as a inverter, and controller 107 causes first switching stage 732 of the switching power converter to act as a rectifier, to transfer energy from low-voltage electric power bus 104 to the battery module. Second switching stage 740 acts as an inverter by converting a DC voltage across terminals 706 and 708 to an AC voltage across second winding 746 of transformer 730, and transformer 730 transforms the AC voltage across second winding 746 to an AC voltage across first winding 738 of transformer 730. First switching stage 732 acts as a rectifier by converting the AC voltage across first winding 738 to a DC voltage across terminals 702 and 704. First capacitor 726 and second capacitor 728 each act as a filter to supply or absorb ripple current generated by switching of first switching stage 732 and second switching stage 740.

Returning to FIGS. 1 and 2, in some embodiments, switching power converters 204 within battery modules 102 have a different electrical topology than that of switching power converters 106 to balance cost and performance of modular battery array 100. In particular, while galvanic isolation may be beneficial or even required in switching power converters 106, galvanic isolation may not be needed in battery modules 102. Therefore, in some embodiments, switching power converters 106 have an isolated electrical topology to achieve galvanic isolation, while switching power converters 204 within battery modules 102 have a non-isolated electrical topology, to promote low cost and small size of battery modules 102. Some possible electrical topologies of switching power converters 204 include, but are not limited to, a buck-type converter, a boost-type converter, a buck-boost-type converter, a Cúk-type converter, a switched capacitor-type converter, and a resonant switching-capacitor-type converter.

In certain embodiments where low-voltage devices 116 include one or more loads, controller 107 is configured to control operation of switching power converters 106 to transfer power to these loads. In some of these embodiments, controller 107 is configured to control switching power converters 106 to regulate one or more parameters on low-voltage bus 104, such as magnitude of voltage Vₗᵥ across low-voltage bus 104. Additionally, controller 107 is optionally capable of controlling switching power converters 106 such that two or more of the switching power converters switch out-of-phase with respect to each other, such as to promote low ripple voltage magnitude on low-voltage electric power bus 104. Furthermore, in some embodiments, controller 107 is configured to operate switching power converters 106 in a burst mode, where switching power converters 106 intermittently transfer power between their respective battery module 102 and low-voltage devices 116, to promote light-load efficiency when low-voltages devices 116 present a light load to modular battery array 100. Moreover, controller 107 is optionally configured to control switching power converters 106 so that only some switching power converter 106 instances operate at a given time, and in some embodiments, controller 107 periodically varies which switching power converter 106 instances are operating, to promote equal use of battery modules 102.

Modular battery array 100 is optionally further configured to perform electrochemical impedance spectroscopy (EIS) on battery cells 202. As known in the art, EIS is a method of extracting complex impedance of a system by measuring a response of the system to a sinusoidal electrical perturbation. Complex impedance of battery cells 202 may be used, for example, to determine one or more of state of charge (SOC) of battery cells 202, state of health (SOH) of battery cells 202, solid electrolyte interface (SEI) layer formation of battery cells 202, and an electrical model of battery cells 202, such as to predict a response of battery cells 202 to a transient electrical load.

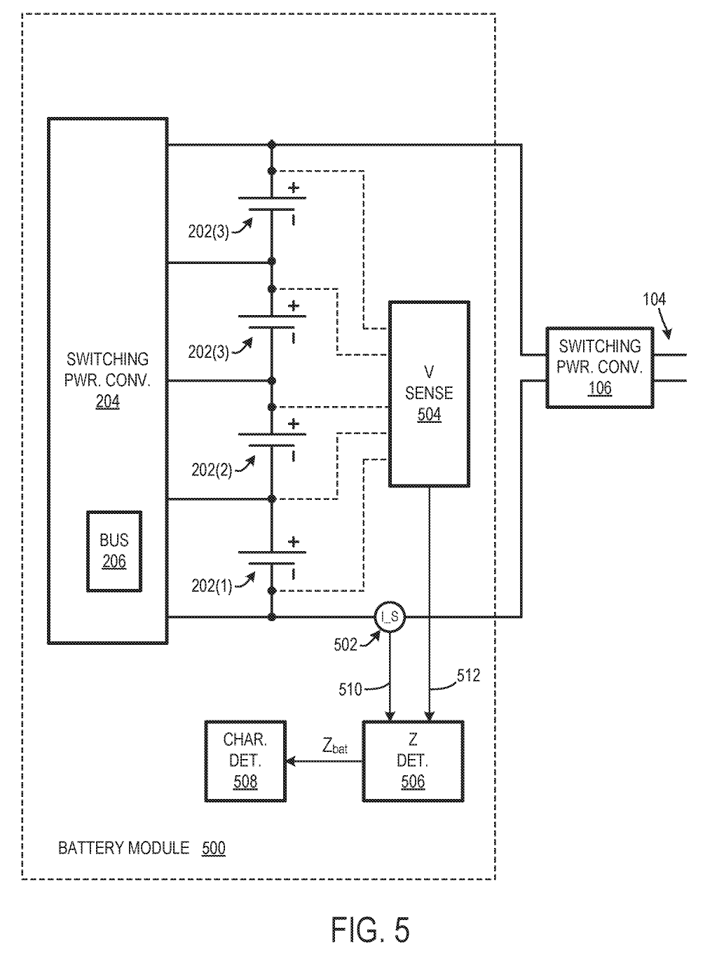

In some embodiments supporting EIS, controller 107 is capable of controlling switching power converters 106 so that each switching power converter 106 generates sinusoidal perturbations at a plurality of frequencies on current flowing through the battery cells 202 of its respective battery module 102. Additionally, in these embodiments, each battery module 102 has the capability of determining impedance of battery cells 202 from battery cell AC voltage and battery cell AC current. For example, FIG. 5 illustrates a battery module 500, which is one embodiment of battery module 102 in an embodiment of modular battery array 100 supporting EIS. Battery module 500 is similar to the battery module illustrated in FIG. 2 but further includes a current sensing module 502, a voltage sensing module 504, an impedance determining module 506, and an optional characteristic determining module 508.

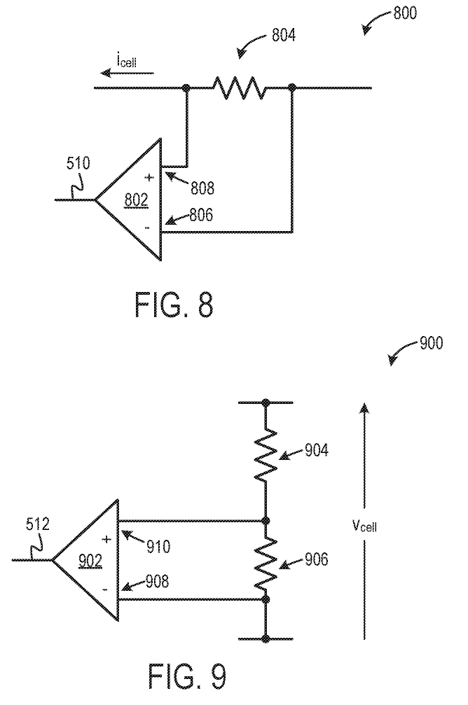

Current sensing module 502 generates signals 510 representing magnitude and phase of current flowing through battery cells 202 of battery module 500. In some embodiments, current sensing module 502 includes one or more high-pass filters so that signals 510 are at least substantially devoid of low-frequency components. FIG. 8 illustrates a current sensing circuit 800, which is one possible embodiment of current sensing module 502. Current sensing circuit 800 includes an amplifier 802 and a sense resistor 804. Sense resistor 804 is electrically coupled in series with battery cells 202 so that current i_{cell} through battery cells 202 generates a voltage across sense resistor 804 that is proportional to magnitude of current i_{cell}. Sense resistor 804 optionally has a low resistance, such as less than one ohm, to promote low power dissipation in sense resistor 804. Inverting input 806 and non-inverting input 808 of amplifier 802 are electrically coupled to opposing respective ends of sense resistor 804, and amplifier 802 generates signal 510 having magnitude A*R*i_{cell}, where A is gain of amplifier 802 and R is resistance of sense resistor 804. Inverting input 806 and non-inverting input 808 could be swapped without departing from the scope hereof. Current sensing circuit 800 optionally includes further components (not shown) to filter signal 510 to remove low-frequency components and high-frequency noise.

Voltage sensing module 504 generates one or more signals 512 representing magnitude and phase of voltage across each battery cell 202. In some embodiments, voltage sensing module 504 includes one or more high-pass filters so that signals 512 are at least substantially devoid of low-frequency components. FIG. 9 illustrates a voltage sensing circuit 900, which is one possible embodiment of a voltage sensing circuit for use in voltage sensing module 504. Voltage sensing circuit 900 includes an amplifier 902, a first resistor 904, and a second resistor 906. Resistors 904 and 906 are electrically coupled in series across a respective battery cell 202, such that voltage v_{cell} across the battery cell is applied across the series combination of resistors 904 and 906. Resistors 904 and 906 collectively divide down magnitude of voltage v_{cell} to value that is compatible with amplifier 902. Inverting input 908 and non-inverting input 910 of amplifier 902 are electrically coupled to opposing respective ends of second resistor 906, and amplifier 902 generates signal 512 having magnitude v_{cell}*A*R906/(R904+R906), where A is gain of amplifier 902, R904 is resistance of first resistor 904, and R906 is resistance of second resistor 906. Voltage sensing circuit 900 optionally includes further components (not shown) to filter signal 512 to remove low-frequency components and high-frequency noise. Voltage sensing module 504 includes, for example, a respective voltage sensing circuit 900 for each battery cell 202.

Impedance determining module 506 determines complex impedance z_{bat} of each battery cell 202 from signals 510 and 512 at each frequency of the sinusoidal perturbations on current through the battery cells, such as by dividing signals 512 by signals 510 using analog circuitry, digital circuitry, or a combination of analog and digital circuitry. Characteristic determining module 508 determines one or more characteristics of each battery cell 202, such as SOC of the battery, SOH of the battery, and/or SEI layer formation of the battery, at least partially based on complex impedance z_{bat}, using techniques known in the art, such as by comparing z_{bat} to complex impedance values in a look-up table correlating complex impedance to battery characteristics.

The series connection of battery cells 202 within battery module 500 enables current flowing through each battery cell 202 to be determined at a single point, thereby promoting simplicity of current sensing module 502. However, switching power converters 204 must have a high impedance if signals 510 are to accurately represent magnitude and phase of current flowing through each battery cell 202. Therefore, in some embodiments of modular battery array 100 supporting EIS, switching power converters 204 operate in a high impedance state while modular battery array 100 performs EIS. Additionally, in certain embodiments, controller 107 causes switching power converters 106 to switch out-of-phase with respect to each other when switching power converters 106 are generating sinusoidal perturbations on current flowing through the battery cells 202 of their respective battery modules, to reduce magnitude of current circulating through low-voltage electric power bus 104.

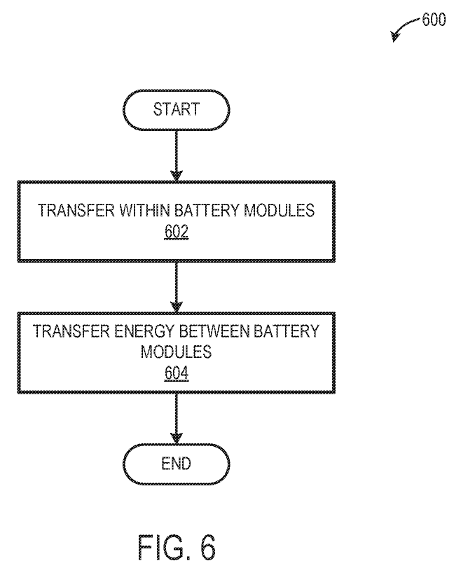

FIG. 6 illustrates a method 600 for balancing energy stored in a modular battery array including a plurality of battery modules electrically coupled in series. In step 602, energy is transferred within battery cells of each battery module using at least one first switching power converter within the module, to balance energy stored in battery cells within the module. In one example of step 602, switching power converters 302 within each battery module 300 transfer energy stored in battery cells 202 within the battery module, to balance energy stored in the battery cells. In step 604, energy is transferred between battery cells of at least two of the battery modules using respective second switching power converters electrically coupled to each of the battery modules, to balance energy stored in the battery modules. In one example of step 604, switching power converters 106 transfer energy between battery modules 300 using low-voltage electric power bus 104, to balance energy stored in battery modules 300.

### Combinations of Features

Features described above as well as those claimed below may be combined in various ways without departing from the scope hereof. The following examples illustrate some possible combinations:

(A1) A modular battery array may include a plurality of battery modules electrically coupled in series to a high-voltage electric power bus, where each of the plurality of battery modules includes a plurality of battery cells electrically coupled in series and at least one first switching power converter for balancing energy stored in the plurality of battery cells of the battery module. The modular battery array may further include a low-voltage electric power bus and a respective second switching power converter electrically interfacing each of the plurality of battery modules with the low-voltage electric power bus.

(A2) The modular battery array denoted as (A1) may further include a controller for controlling the second switching power converters to balance energy stored in the plurality of battery modules.

(A3) In either of the modular battery arrays denoted as (A1) or (A2), each first switching power converter may have a first electrical topology, and each second switching power converter may have a second electrical topology different from the first electrical topology.

(A4) In any of the modular battery arrays denoted as (A1) through (A3), each second switching power converter may be an isolated switching power converter.

(A5) In any of the modular battery arrays denoted as (A1) through (A4), the at least one first switching power converter in each of the plurality of battery modules may be a ladder converter.

(A6) In any of the modular battery arrays denoted as (A1) through (A5), each second switching power converter may be configured to generate a sinusoidal perturbation on electric current flowing through the plurality of battery cells of its respective battery module, and each of the plurality of battery modules may further include: (a) a current sensing module configured to determine an alternating current (AC) component of the electric current flowing through the plurality of battery cells of the battery module, (b) a voltage sensing module configured to determine an AC component of a respective voltage across each of the plurality of battery cells, and (c) an impedance determining module configured to determine a complex impedance of each of the plurality of battery cells based at least in part on the AC component of the electric current flowing through the plurality of battery cells of the battery module and the AC component of the respective voltage across each of the plurality of battery cells of the battery module.

(A7) In any of the modular battery arrays denoted as (A1) through (A6), the modular battery array may be configured such that a magnitude of a voltage across the high-voltage electric power bus is greater than a magnitude of a voltage across the low-voltage electric power bus during normal operation of the modular battery array.

Changes may be made in the above-described modular battery arrays and methods without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and modular battery arrays, which, as a matter of language, might be said to fall therebetween.

What is claimed is:

1. A modular battery array, comprising:
a plurality of battery modules electrically coupled in series to a high-voltage electric power bus, each of the plurality of battery modules including:
a plurality of battery cells electrically coupled in series, and
at least one first switching power converter for balancing energy stored in the plurality of battery cells of the battery module;
a low-voltage electric power bus; and
a respective second switching power converter electrically interfacing each of the plurality of battery modules with the low-voltage electric power bus.

2. The modular battery array of claim 1, further comprising a controller for controlling the second switching power converters to balance energy stored in the plurality of battery modules.

3. The modular battery array of claim 2, each first switching power converter having a first electrical topology, and each second switching power converter having a second electrical topology different from the first electrical topology.

4. The modular battery array of claim 3, each second switching power converter being an isolated switching power converter.

5. The modular battery array of claim 4, the at least one first switching power converter in each of the plurality of battery modules being a ladder converter.

6. The modular battery array of claim 1, wherein each second switching power converter is configured to generate a sinusoidal perturbation on electric current flowing through the plurality of battery cells of its respective battery module, and each of the plurality of battery modules further includes:
a current sensing module configured to determine an alternating current (AC) component of the electric current flowing through the plurality of battery cells of the battery module;
a voltage sensing module configured to determine an AC component of a respective voltage across each of the plurality of battery cells; and
an impedance determining module configured to determine a complex impedance of each of the plurality of battery cells based at least in part on the AC component of the electric current flowing through the plurality of battery cells of the battery module and the AC component of the respective voltage across each of the plurality of battery cells of the battery module.

7. The modular battery array of claim 1, the modular battery array being configured such that a magnitude of a voltage across the high-voltage electric power bus is greater than a magnitude of a voltage across the low-voltage electric power bus during normal operation of the modular battery array.

8. A method for balancing energy stored in a modular battery array including a plurality of battery modules electrically coupled in series, comprising:
in each of the plurality of battery modules, transferring energy between battery cells within the battery module using at least one first switching converter within the battery module, to balance energy stored in the battery cells within the battery module; and
transferring energy between battery cells of at least two of the plurality battery modules using respective second switching power converters electrically coupled to each of the plurality of battery modules, to balance energy stored in the plurality of battery modules.

9. The method of claim 8, further comprising:
generating a sinusoidal perturbation on electric current flowing through battery cells of one of the plurality of battery modules using the second switching power converter electrically coupled to the battery module;
determining an alternating current (AC) component of the electric current flowing through the battery cells of the battery module;
determining an AC component of a respective voltage across each of the battery cells of the battery module; and
determining a complex impedance of each of the battery cells of the battery module based at least in part on the AC component of the electric current flowing through the battery cells of the battery module and the AC component of the respective voltage across each of the battery cells of the battery module.
